(19) United States
(12) Patent Application Publication
(10) Pub. No.: US 2026/0013421 A1
(43) Pub. Date: Jan. 15, 2026

(54) Row Unit for an Agricultural Sowing Machine and Method For Determining a Depositing Depth and/or Covering Height

(71) Applicant: Amazonen-Werke H. Dreyer Se & Co. kg, Hasbergen (DE)

(72) Inventors: Roland ARNOLD, Ganderkesee (DE); Daniel MERTENS, Oldenburg (DE); Mario WESSELS, Ganderkesee (DE); Thomas WESSELS, Osnabrück (DE); Jens KOCH, Uelzen (DE); Waldemar BANGERT, Berge (DE)

(73) Assignee: Amazonen-Werke H. Dreyer Se & Co. kg, Hasbergen (DE)

(21) Appl. No.: 18/863,719

(22) PCT Filed: May 2, 2023
(86) PCT No.: PCT/EP2023/061464

§ 371 Date: Nov. 7, 2024

(30) Foreign Application Priority Data
May 10, 2022 (DE) 10 2022 111 583.6

(51) Int. Cl. A01C 7/20; A01C 5/06

(52) U.S. Cl. CPC A01C 7/203; A01C 5/064; A01C 5/068

(57) ABSTRACT

A row unit for a sowing machine for depositing material to be distributed, comprising at least one furrow opening element which is provided to open a seed furrow; at least one depth guidance element which is provided to set a defined depositing depth and/or covering height for the material to be distributed; and at least one associated electronic evaluation device which comprises several sensors associated to the row unit, wherein the sensors are configured to scan the arable land within a detection region associated with the respective sensors, and wherein the evaluation device is configured to determine by way of the sensors the depositing depth and/or covering height of the material to be distributed that is deposited in the seed furrow. In order to further improve the depositing accuracy and/or depositing quality of the material to be distributed in a simple manner, it is provided that the sensors are arranged such that said detection region of the several sensors during the deposition of the material to be spread and in the direction of travel and/or work of the row unit is arranged and/or disposed behind a bearing surface of the at least one depth guidance element.

### CROSS REFERENCE TO RELATED APPLICATIONS

The present application claims priority under 35 U.S.C. § 365 to PCT/EP2023/061464 filed on May 2, 2023 and under 35 U.S.C. § 119(a) to German Application No. 10 2022 111 583.6 filed on May 10, 2022.

### BACKGROUND

The disclosure relates to a row unit for an agricultural sowing machine for depositing material to be spread on agricultural arable land, to an agricultural sowing machine, and to a method for determining a depositing depth and/or covering height of a material to be spread on agricultural arable land by way of a row unit of an agricultural sowing machine.

In the field of agriculture, a plurality of different variants of sowing machines for spreading or depositing material to be spread, in particular seed and/or fertilizer, are known. In addition to pneumatic and/or mechanical sowing machines, these also include single grain sowing machines which are configured to deposit the material to be spread on agricultural arable land by way of at least one row unit or a sowing assembly, respectively.

A generic row unit is known, for example, from publication EP3704 926 A1. According thereto, the row unit comprises at least one furrow opening element, in particular a colter, which is provided for opening a seed furrow. Furthermore, the row unit comprises at least one material depositing device which is provided for supplying the material to be spread as required and for depositing the material to be spread within the seed furrow. Beyond that, the row unit comprises at least one depth guidance element which is provided for setting a defined depositing depth and/or covering height for the material to be spread and/or a defined penetrating depth of the furrow opening element into the ground of the arable land. In addition, the row unit comprises at least one associated electronic evaluation device which comprises several sensors associated with the row unit and configured to scan the arable land, in particular the seed furrow and/or the ground of the arable land, without contact within a detection region associated with the respective sensors. The evaluation device is configured to determine by way of the sensors the depositing depth and/or covering height of the material to be spread in the seed furrow and/or the penetrating depth of the furrow opening element. The evaluation device is configured in particular to compute and/or take into account individual sensor signals from the several sensors for determining the depositing depth and/or covering height.

The disadvantage of row units configured in this manner is that at least one of the several sensors, in particular detection regions, is arranged and/or located in the direction of travel and/or work forward of the at least one depth guidance element. In particular, it is disadvantageous that the depositing depth and/or covering height is determined using sensors, of which, in particular only one of the several sensors is arranged and/or located behind the depth guidance element and at least one other of the several sensors is arranged and/or located forward of the depth guidance element. Ground movements of the arable land, which depend on the conditions of the soil, a bearing force of the at least one depth guidance element (colter pressure of the row unit) and/or the furrow opening element, can only be inadequately detected and/or taken into account with sensors, in particular detection regions, arranged in this manner.

### SUMMARY

The depositing accuracy and/or depositing quality of the material to be spread, however, could be further improved in a simple manner if such ground movements or compaction of the arable soil were detected and/or taken into account with greater precision. The object underlying the disclosure is therefore to further increase the precision in the sensor-supported detection of the depositing depth and/or covering height of the material to be spread.

This object can be satisfied according to the disclosure by having sensors arranged such that the detection region of the several sensors during the deposition of the material to be spread and in the direction of travel and/or work of the row unit is arranged and/or disposed behind a bearing surface of the at least one depth guidance element.

As a result of this measure, the region of the arable land or the ground located behind the at least one depth guidance element can be detected simultaneously by several sensors. The several sensors there preferably each detect different regions of the ground. Alternatively or additionally, the sensors can be arranged and/or oriented such that the detection regions overlap at least in part. The different detection regions can there be arranged offset from one another in and/or transverse to the direction of travel and/or work. Furthermore, at least one further sensor can also be associated with the row unit and configured to detect the arable land or the ground in the direction of travel and/or work forward of the at least one depth guidance element. In addition, the evaluation device is preferably also configured to take into account geometry and/or positional information of the row unit for determining the depositing depth and/or covering height. In particular, a respective sensor position and/or sensor location relative to the ground (e.g. sensor distance from the ground) can then be taken into account. The evaluation device is preferably further configured to take into account the individual sensor signals of the several sensors for determining the depositing depth and/or covering height of the material to be spread and/or for determining the penetrating depth of the furrow opening element. Such an embodiment has the decisive advantage that the region and/or several different regions behind the at least one depth guidance element can be detected by several sensors, whereby the precision of the detection of the depositing depth and/or covering height of the material to be spread is further increased.

The row unit preferably comprises several depth guidance elements, each of which is associated with one or more furrow opening elements. The depth guidance elements are preferably configured in the manner of support rollers or depth guidance rollers or the like. Particularly preferably, at least one of the depth guidance elements is arranged, as seen in the direction of travel, to the left and at least one other of the depth guidance elements is arranged to the right of the furrow opening element, in particular of the seed furrow.

The at least one furrow opening element is also preferably configured in the manner of a colter, in particular a chisel or tine colter or a disk colter. However, the row unit particularly preferably comprises several furrow opening elements which preferably form a double disk colter.

The several sensors can be configured in the manner of optical and/or acoustic sensors. In particular, sensors are provided which are configured in the manner of ultrasound, radar, lidar and/or laser sensors. Furthermore, camera-based or image-capturing sensors are also conceivable. Alternatively or additionally, it is also conceivable to combine differently configured sensors with one another.

In a preferred embodiment of the row unit according to the disclosure, the several sensors are arranged in the direction of travel and/or work of the row unit behind the bearing surface, in particular an axis of rotation, of the at least one depth guidance element. The bearing surface forms in particular the region of the ground over which the at least one depth guidance element is supported on the ground and/or over which the weight and/or a colter pressure of the row unit is transferred at least substantially onto the ground. If there are several depth guidance elements, each of the depth guidance elements comprises a respective bearing surface. The depth guidance elements are preferably configured in the manner of depth guidance rollers which are arranged so as to be rotatable about an axis or axis of rotation arranged transverse to the direction of travel and/or work. With such an embodiment, the sensors are arranged particularly close to the intended detection regions, whereby the region behind the at least one depth guidance element can be detected with particularly high precision and/or in an unobstructed manner.

In a further development of the row unit according to the disclosure, the detection region of at least one of the several sensors is oriented at least in part toward a region of the ground pressed on by the at least one depth guidance element, preferably a track of the depth guidance element. At least one of the sensors is configured to detect the track of the at least one depth guidance element, in particular the depth of the track. The track is a strip on the ground of the arable land that the at least one depth guidance element travels over or forms, which is immediately pressed on and/or compacted by the depth guidance element. When using several depth guidance elements, each of the depth guidance elements forms its own track on the ground.

In another preferred embodiment of the row unit according to the disclosure, the detection region of at least one of the several sensors is oriented at least in part toward the opened seed furrow. The at least one sensor is configured to detect the depth and/or contour of the seed furrow.

In another further development of the row unit according to the disclosure, the detection region of a first one of the several sensors is oriented toward the region of the ground pressed on by the at least one depth guidance element, preferably the track, and of a second one of the several sensors is oriented toward the opened seed furrow. In other words, the several sensors are preferably arranged such that at least one of the sensors is configured to detect the track of the at least one depth guidance element, while at least one other of the several sensors is configured to detect the seed furrow opened and/or formed by the furrow opening element. In particular, it is provided that the evaluation device is configured to take into account or compute the depth and/or contour of the track and of the seed furrow for determining the depositing depth, the covering height, and/or the penetrating depth. In such an embodiment, the evaluation device takes into account different height levels and/or soil layers of the arable land, whereby the accuracy in determining the depositing depth, the covering height, and/or the penetrating depth is further improved.

In another development of the row unit according to the disclosure, the detection region of one of the several sensors is oriented toward the region of the soil pressed on by the at least one depth guidance element, preferably the track of the depth guidance element, on the one hand, and the open seed furrow, on the other hand. The at least one sensor is therefore configured to detect both the depth and/or contour of the seed furrow as well as of the track of the depth guidance element. Alternatively or additionally, when using several depth guidance elements, it can be provided that at least one of the sensors is configured to detect the seed furrow and the track of the one depth guidance element, while the at least one other sensor is configured to detect the seed furrow and the track of the other depth guidance element.

It can also preferably be provided that the evaluation device is configured to generate individual average values based on the distances to the ground detected by the sensors and to take these into account when determining the depositing depth and/or covering height. Alternatively or additionally, it would also be conceivable for the evaluation device to be configured to determine average values for the depositing depth and/or covering height on the basis of the sensor signals.

In a further preferred embodiment of the row unit according to the disclosure, the sensors, preferably the detection regions of the sensors, are offset from one another transverse to the direction of travel and/or work of the row unit.

The row unit also preferably comprises at least one furrow closing and/or pressing element which is arranged in the direction of travel and/or work, preferably at a distance, behind the furrow opening element. The furrow closing and/or pressing element is configured to close and/or press on the seed furrow at least in part after the material to be spread has been deposited.

In a preferred development of the row unit according to the disclosure, the detection region of one of the several sensors is arranged behind the furrow closing and/or pressing element and the detection region of at least one other of the several sensors is arranged forward thereof. The at least one furrow closing and/or pressing element is preferably configured in the manner of a reflection and/or pressing roller. The row unit preferably comprises several furrow closing and/or pressing elements which are particularly preferably positioned and/or angled relative to one another. With sensors arranged in this manner, the evaluation device is configured to take into account the soil additionally thrown up onto the seed furrow and/or compacted by the furrow closing and/or pressing element.

Furthermore, a row unit according to the disclosure is preferred in which at least one of the several sensors is arranged and configured to detect the material to be spread that is pressed into the seed furrow at least in part by a catch and/or pressing roller arranged behind the furrow opening element and/or the depth guidance element. The evaluation device is preferably configured to take the material to be spread that is detected and/or pressed on into account when determining the depositing depth and/or covering height. The evaluation device is particularly preferably configured based on the detected material to be spread that is pressed on to determine the height and/or the proportion with which the material to be spread is pressed into the seed furrow. This embodiment has a particularly high level of precision in determining the depositing depth and/or covering height of the material to be spread.

In another preferred embodiment of the row unit according to the disclosure, the evaluation device is configured to verify the plausibility of the detected and/or determined depositing depth and/or covering height or the sensor signals based on predefinable operating parameters, respectively. The evaluation device is preferably configured to take into account and/or filter sensor signals generated by the sensors as a function of the plausibility, in particular of the operating parameters. In particular, a predefinable and/or detectable colter pressure and/or a predefinable and/or detectable bearing force of the row unit are provided there as operating parameters. Alternatively or additionally, the nature of the arable land, for example the temperature and/or moisture of the soil, can also be taken into account by way of the operating parameter.

Furthermore, it can preferably also be provided that the evaluation device is configured to take into account or to compute the sensor signal of a single one of the sensors in different ways and as a function of the plausibility. In the case of a sensor which is configured to detect both the seed furrow as well as the track, either the distance to the seed furrow or to the track can be taken into account depending on the plausibility.

The evaluation device can also be configured to verify the plausibility once or repeatedly within a predefinable and/or adjustable period of time during the work process. Alternatively, the evaluation device can also be configured to verify the plausibility continuously or during the entire work process. The evaluation device is preferably configured to take into account the sensor signals as a function of the plausibility, in particular the operating parameters, with different weighting for determining the depositing depth and/or covering height. The evaluation device is particularly preferably configured to take into account different sensor signals as a function of the plausibility, in particular of the operating parameters, for determining the depositing depth and/or covering height. It can there be provided, for example, that in the case of positive plausibility, a sensor signal associated with detecting the seed furrow and in the case of negative plausibility, a sensor signal associated with detecting the track (or vice versa) is taken into account by the evaluation device. In addition, a depositing depth and/or covering height that depends on the operating parameters and is to be expected (computationally) can be provided and is taking into account during the verification of the plausibility and/or in particular is compared with the depositing depth and/or covering height determined on the basis of the sensor signals. Furthermore, it can be provided that a corrected depositing depth and/or covering height is determined by the evaluation device in case of negative plausibility.

The object underlying the disclosure is also satisfied by an agricultural sowing machine with one or more row units for depositing material to be spread, where the one or more row units are configured according to at least one of the above-described embodiments of the row unit according to the disclosure. With regard to the advantages and modifications of the sowing machine according to the disclosure, reference is therefore first made to the advantages and modifications of the row unit according to the disclosure.

The agricultural sowing machine is particularly preferably configured in the manner of a single grain sowing machine and is intended for depositing seed and/or fertilizer.

The object underlying the disclosure is also satisfied by a method for determining a depositing depth and/or covering height of material to be spread that is deposited on agricultural arable land by way of a row unit of an agricultural sowing machine, where the row unit is configured according to one of the above-described embodiments. With regard to the advantages and modifications of the method according to the disclosure for determining a depositing depth and/or covering height, reference is therefore first made to the advantages and modifications of the row unit according to the disclosure.

In the method according to the disclosure, a seed furrow is opened along the arable land by way of at least one furrow opening element, in particular a colter that is associated with the row unit. Furthermore, the material to be spread is delivered to and/or deposited within the seed furrow by way of at least one material depositing device associated with the row unit. In the meantime, a defined depositing depth and/or covering height for the material to be spread and/or a defined penetrating depth of the furrow opening element into the soil of the arable land is set by way of at least one depth guidance element associated with the row unit. Furthermore, a depositing depth and/or covering height of the material to be spread that is deposited in the seed furrow is determined and/or detected by way of at least one evaluation device associated with the row unit. For this purpose, the evaluation device comprises several sensors which scan the arable land, preferably the seed furrow and/or the ground of the arable land, without contact within a detection region associated with the respective sensors while the material to be spread is deposited.

In a particularly preferred embodiment of the method according to the disclosure, the arable land, in particular the seed furrow and/or the ground of the arable land, behind the bearing surface of the at least one depth guidance element is detected and/or scanned using the sensors, in particular the detection region of the sensors.

### BRIEF DESCRIPTION OF THE DRAWINGS

Further details of the disclosure are to be gathered from the description of the examples and the drawings, where the drawing in

FIG. 1 shows an agricultural sowing machine configured as a single grain sowing machine attached behind a tractor with a plurality of row units according to the disclosure in a perspective view;

FIG. 2 shows a row unit according to the disclosure in a perspective single view; and

FIG. 3 shows the row unit according to the disclosure in a sectional view from behind.

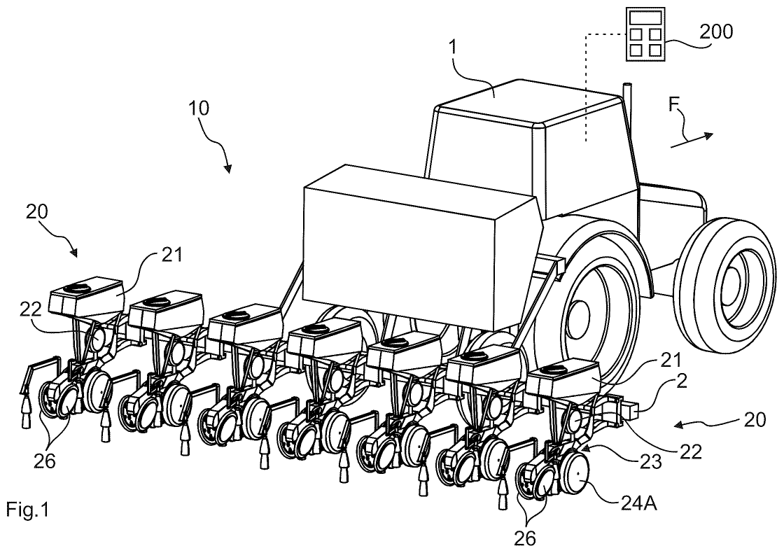

An agricultural sowing machine attached behind a tractor 1 and configured as a single grain sowing machine 10 can be seen in FIG. 1. Single grain sowing machine 10 comprises a plurality of sowing assemblies arranged transverse to direction of travel F on a beam 2, each of which is configured in the manner of agricultural row units 20 and is intended to deposit material to be spread on agricultural arable land.

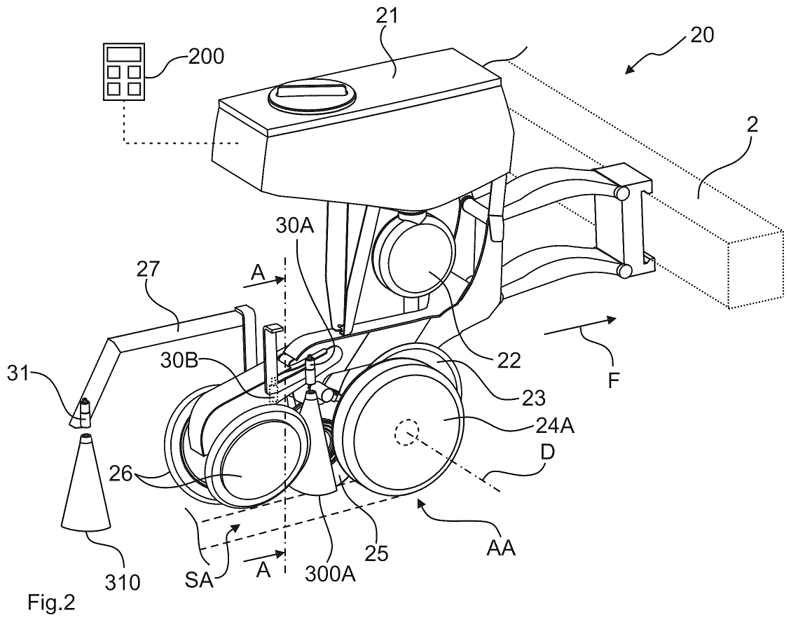

As can be seen particularly well in FIG. 2, row units 20 each comprise a container 21 on their upper side for storing the material to be spread, presently seed. From container 21, the material to be spread, configured as seed, passes into a singling element 220 (not shown in detail) of a material depositing device 22 from which it is delivered toward ground B of the arable land as required and/or at regular intervals and is deposited in one of several seed furrow 230 formed or opened by furrow opening elements 23, presently only shown in part. Furrow opening elements 23 can be configured in the manner of double disk colters known per se. Alternatively, row unit 20 can also comprise only one furrow opening element 23 which is configured, for example, in the manner of a chisel or tine colter. Furthermore, a combination of different furrow opening elements, for example at least one disk colter with a tine colter or the like, would also be conceivable. Furrow opening elements 23 serve to open a seed furrow 230 in ground B into which individual grains K of the material to be spread are deposited.

Furthermore, row unit 20 comprises several depth guidance elements 24A, 24B, presently configured in the manner of depth guidance and/or support rollers, which are provided for setting a defined depositing depth and/or covering height for the material to be spread and/or a defined penetrating depth of furrow opening elements 23 into ground B of the arable land. As an alternative to the embodiment shown, a row unit 20 would also be conceivable which comprises only one depth guidance element 24A, 24B. Depth guidance elements 24A, 24B are arranged within row unit 20 so as to be rotatable about an axis of rotation D and are each supported on ground B by way of a bearing surface AA, AB. The weight and/or an adjustable colter pressure of row unit 20 is transferred to ground B by way of respective bearing surface AA, AB.

In addition, row unit 20 is associated with an electronic evaluation device 200 which comprises several sensors 30A, 30B, 31 associated with row unit 20. Sensors 30A, 30B, 31 are arranged there on row unit 20 and are configured to scan the arable land, in particular seed furrow 230 and/or ground B of the arable land without contact within a detection region 300A, 300B, 310 associated with respective sensors 30A, 30B, 31. Sensors 30A, 30B, 31 are arranged according to the disclosure such that detection region 300A, 300B, 310 of several sensors 30A, 30B, 31 during the deposition of the material to be spread and in direction of travel and/or work F of row unit 20 is arranged and/or disposed behind bearing surface AA, AB of depth guidance elements 24A, 24B. Furthermore, evaluation device 200 is configured to determine, by way of sensors 30A, 30B, 31 or detected and/or scanned ground B of the arable land, the depositing depth and/or covering height of the material to be spread that is deposited in seed furrow 230 and/or the penetrating depth of furrow opening element 23.

As can be seen in particular in FIG. 2, several sensors 30A, 30B, 31 are arranged in direction of travel and/or work F of row unit 20 behind bearing surface AA, AB, in particular an axis of rotation D, of depth guidance elements 24A, 24B.

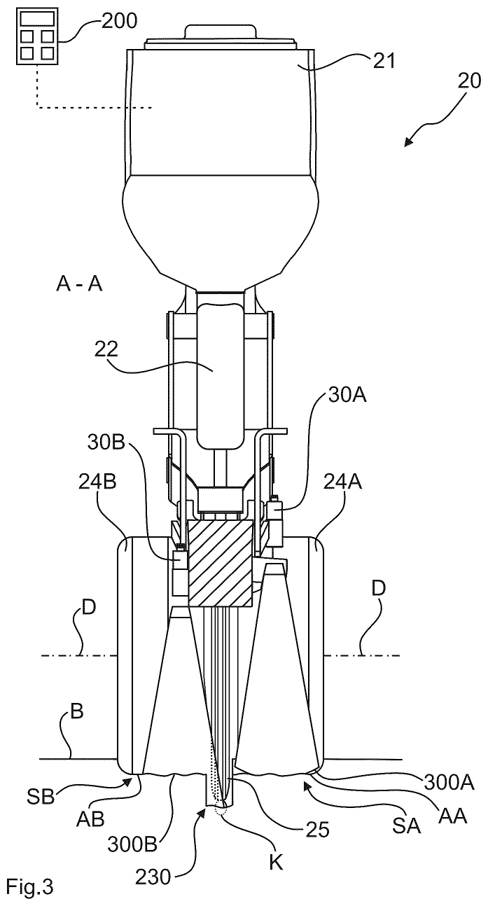

As can be seen better in FIG. 3, detection region 300A, 300B of a first one and a second one of several sensors 30A, 30B is oriented at least in part toward a region of ground B pressed on by depth guidance elements 24A, 24B, in particular a track SA, SB of depth guidance elements 24A, 24B. Sensors 30A, 30B, in particular detection regions 300A, 300B of sensors 30A, 30B, are offset from one another transverse to direction of travel and/or work F of row unit 20 such that, during the working process, first sensor 30A detects and/or scans track SA of depth guidance element 24A as seen in direction of travel F on the right-hand side and second sensor 30B detects and/or scans track SB of depth guidance element 24B as seen in direction of travel F on the left-hand side.

As is also evident, second sensor 30B or its detection region 300, respectively, is presently arranged and/or oriented such that the opened seed furrow 230 is detected and/or scanned at least in part by second sensor 30B during the working process. Second sensor 30B is therefore configured to detect at least in part the depth and/or contour of seed furrow 230.

In other words, detection region 300A of first sensor 30A is oriented toward at least one region of ground B pressed on by depth guidance elements 24A, 24B, in particular track SA, SB, while detection region 300B of second sensor 30B is oriented toward opened seed furrow 230. Second sensor 30B or its detection region 300, respectively, can also be arranged such that it alternatively or additionally detects and/or scans track SB of respective other depth guidance element 24B.

FIGS. 2 and 3 also show an optional catch and/or pressing roller 25 which is arranged in direction of travel and/or work F in particular directly behind furrow opening element 23 and/or depth guidance elements 24A, 24B. Catch and/or pressing roller 25 is configured to press and/or sink grains K of the material to be spread, which are delivered and/or deposited by material depositing device 22, at least in part into the ground of seed furrow 230. Evaluation device 200 is configured to take into account the pressed material to be spread detected by sensors 30B when determining the depositing depth and/or covering height. Evaluation device 200 is configured in particular to determine and take into account the height and/or proportion with which the material to be spread or grains K, respectively, are pressed onto seed furrow 230.

FIG. 2 also shows a furrow closing and/or pressing element 26 which is arranged in direction of travel and/or work F, in particular at a distance behind furrow opening element 23 and which is presently configured as furrow closing and/or pressing rollers which are arranged in a V-shape relative to one another. Furrow closing and/or pressing elements 26 are configured to close and/or press on seed furrow 230 at least in part after the material to be spread has been deposited.

It should be explicitly mentioned presently that row unit 20 can alternatively also comprise a single furrow closing and/or pressing element 26 which is intended to close and/or press on seed furrow 230.

Furthermore, an optional further sensor 31 can be seen which is arranged at row unit 20 by way of a holding device 27, which is likewise optional.

Detection region 310 of optional further sensor 31 is there arranged and/or oriented behind furrow closing and/or pressing elements 26, while detection region 300A, 300B of at least one other sensor 30A, 30B, presently first and/or second sensor 30A, 30B, is arranged and/or oriented forward of furrow closing and/or pressing elements 26.

Alternatively or additionally, it would also be conceivable for detection region 300A, 300B of first or second sensor 30A, 30B to be oriented toward the region behind furrow closing and/or pressing elements 26.

It is further to be mentioned that evaluation device 200 is optionally configured to verify the plausibility of the detected and/or determined depositing depth and/or covering height or the sensor signals, respectively, based on predefinable operating parameters. Evaluation device 200 is in particular configured to take into account and/or filter sensor signals generated by sensors 30A, 30B, 31 as a function of the plausibility, in particular of the operating parameters.

Furthermore, evaluation device 200 can alternatively or additionally be configured to take into account the sensor signals as a function of the plausibility and/or operating parameters with different weighting for determining the depositing depth and/or covering height.

For example, it can be provided that evaluation device 200 monitors the operating parameter, e.g. the colter pressure, and compares it with the sensor signals and/or the depositing depth and/or covering height determined. For example, an electronic characteristic field, an electronic function or the like can also be definable, which assigns e.g. colter pressure, defined target depositing depths, or target sensor signals to the respective operating parameters. Depending on the plausibility, e.g. in the case of negative plausibility, it can be provided that evaluation device 200 weights one or more of several sensors 30A, 30B, 31 differently, or ignores or does not take them into account, at least temporarily. For example, in the case of negative plausibility, it can be provided that evaluation device 200 determines the depositing depth and/or covering height, at least temporarily, only based on one of sensors 30A, 30B, 31.

Furthermore, it can also be provided that evaluation device 200 is configured to take the sensor signal of a single sensor 30A, 30B, 31 into account or calculate it in different ways and as a function of the plausibility. For example, it can be presently provided that, based on the sensor signal of second sensor 30B, which is oriented both toward track SB of depth guidance element 24B as well as toward seed furrow 230, the distance to the bottom of seed furrow 230 is taken into account primarily or in the event of positive plausible, the distance to the bottom of track SB is taken into account secondarily or in the event of negative plausible, for determining the depositing depth and/or covering height. Of course, the evaluation can here also be carried out vice versa. Furthermore, such filtering of the sensor signals would also be conceivable alternatively or additionally for the others of several sensors 30A, 31.

The at least one operating parameter can be, for example, a colter pressure or the like that can be set at row unit 20 and which is determinable, retrievable, and/or detectable Alternatively or additionally, the operating parameter can also be an environmental condition, such as the condition of the arable land, e.g. temperature and/or moisture of the soil. Furthermore, detectable loads and/or forces at row unit 20, in particular at depth guidance element 24A, 24B or furrow opening elements 23, would also be conceivable as operating parameters.

It goes without saying that the features mentioned in the embodiments described above are not restricted to these special combinations and are also possible in any other combination. Furthermore, it goes without saying that the geometries shown in the figures are only by way of example and are also possible in any other configuration.

### LIST OF REFERENCE CHARACTERS

1 agricultural tractor
2 beam
10 single grain sowing machine
20 row unit
200 evaluation device
21 container
22 material depositing device
220 singling device
23 furrow opening element
230 seed furrow
24A, 24B depth guidance element
25 catch and/or pressing roller
26 furrow closing and/or pressing element
27 holding device
30A first sensor
300A detection region of first sensor
30B second sensor
300B detection region of second sensor
31 further sensor
310 detection region of further sensor
AA, AB bearing surfaces
B. ground
D axis of rotation
F direction of travel
K grains
SA, SB tracks

1. A row unit for an agricultural sowing machine for depositing material to be spread on agricultural arable land, comprising;
at least one furrow opening element, in particular a colter, which is provided for opening a seed furrow;
at least one material depositing device which is provided for supplying the material to be spread as required and for depositing the material to be spread within said seed furrow;
at least one depth guidance element which is provided for setting a defined depositing depth and/or covering height for the material to be spread and/or a defined penetrating depth of the furrow opening element into the ground of the arable land; and
at least one associated electronic evaluation device which comprises several sensors associated with said row unit, wherein said several sensors are configured to scan the arable land, preferably said seed furrow and/or said ground of the arable land, without contact within a detection region associated with said several sensors, and wherein said evaluation device is configured to determine by way of said several sensors the depositing depth and/or covering height of the material to be spread that is deposited in said seed furrow and/or the penetrating depth of said furrow opening element;
wherein said several sensors are arranged such that said detection region of said several sensors during the deposition of the material to be spread and in the direction of travel and/or work of said row unit is arranged and/or disposed behind a bearing surface of said at least one depth guidance element.

2. The row unit according to claim 1, wherein said several sensors are arranged in said direction of travel and/or work of said row unit behind an axis of rotation, of said at least one depth guidance element.

3. The row unit according to claim 1, wherein said detection region of at least one of said several sensors is oriented at least in part toward a region of said ground pressed on by said at least one depth guidance element, preferably a track of said depth guidance element.

4. The row unit according to claim 1, wherein said detection region of at least one of said several sensors is at oriented at least in part toward said open seed furrow.

5. The row unit according to claim 3, wherein said detection region of a first one of said several sensors is oriented toward the region of said ground pressed on by said at least one depth guidance element, and of a second one of said several sensors is oriented toward said open seed furrow.

6. The row unit according to claim 3, wherein said detection region of one of said several sensors is oriented toward the region of said ground pressed on by said at least one depth guidance element.

7. The row unit according to claim 1, wherein said detection regions of said sensors, are offset from one another transverse to said direction of travel and/or work of said row unit.

8. The row unit according to claim 1, further comprising at least one furrow closing and/or pressing element which is arranged in said direction of travel and/or work preferably at a distance behind said furrow opening element and is configured to close and/or press on said seed furrow at least in part after the material to be spread has been deposited, wherein said detection region of one of said several sensors is arranged or disposed behind said furrow closing and/or pressing element and said detection region of at least one other of said several sensors forward of said furrow closing and/or pressing element.

9. The row unit according to claim 1, wherein at least one of said several sensors is arranged and configured to detect the material to be spread that is pressed into said seed furrow at least in part by a catch and/or pressing roller arranged behind said furrow opening element and/or said depth guidance element, wherein said of evaluation device is configured to take the material to be spread that is detected and pressed on into account when determining the depositing depth and/or covering height, and wherein said evaluation device is configured, based on the detected material to be spread that is pressed on, to determine the height and/or the proportion with which the material to be spread is pressed into said seed furrow.

10. The row unit according to claim 1, wherein said evaluation device is configured to verify the plausibility of the determined depositing depth and/or covering height based on predefinable operating parameters, wherein said evaluation device is configured to take into account and/or filter sensor signals generated by said sensors as a function of the plausibility of the operating parameters.

11. An agricultural sowing machine for depositing material to be spread on agricultural arable land; with one or more row units, wherein said one or more row units are configured according to claim 1.

12. MA method for determining a depositing depth and/or covering height of a material to be spread that has been deposited on agricultural arable land by way of a row unit of an agricultural sowing machine, comprising:
opening a seed furrow along the arable land by way of at least one furrow opening element associated with said row unit;
supplying and/or depositing the material to be spread within said seed furrow by way of at least one material depositing device associated with said row unit;
setting a defined depositing depth and/or covering height for the material to be spread and/or a defined penetrating depth of said furrow opening element into said ground of the arable land by way of at least one depth guidance element associated with said row unit; and
detecting and/or determining a depositing depth and/or covering height of the material to be distributed, that is deposited in said seed furrow by way of at least one evaluation device associated with said row unit, wherein said evaluation device comprises several sensors which scan the arable land without contact within a detection region associated with said respective sensors while the material to be spread is deposited;
wherein said sensors are arranged such that said detection region of said several sensors during the deposition of the material to be spread and in said direction of travel and/or work of said row unit is disposed behind a bearing surface of said at least one depth guidance element.

13. The method according to claim 12, wherein said seed furrow and/or said ground of the arable land, behind said bearing surface of said at least one depth guidance element is detected and/or scanned by said sensors.

14. (canceled)

15. The row unit according to claim 10, wherein predefinable operating parameters are at least one of a colter pressure, a bearing force of said row unit and a condition of the arable land.
